(19) United States
(12) Patent Application Publication
(10) Pub. No.: US 2007/0207236 A1
(43) Pub. Date: Sep. 6, 2007

(54) MOLD ASSEMBLY

(75) Inventor: Wen-Ssu Chiu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,822

(22) Filed: Dec. 27, 2006

(30) Foreign Application Priority Data
Mar. 3, 2006 (CN) 200610034161.8

(51) Int. Cl. B29C 33/44

(52) U.S. Cl. 425/468; 425/192 R; 425/577

(57) ABSTRACT

A mold assembly (100) is provided including a mold plate (20), a mold core (30), a mold holder (10), an elastic member (80), and an adjusting block (40). The mold plate has a receiving cavity (14) defined therein. The mold plate is received within and fixed to the mold holder, and the mold core is movably received in the receiving cavity. The elastic member abuts the mold plate and the mold core. The adjusting member is movably received in the receiving cavity and is configured to selectably drive the adjusting block to move relative to the mold plate and to thereby adjust the position of the mold core in the receiving cavity.

### BACKGROUND OF THE INVENTION

1. Field of the Invention

The present invention relates generally to mold assemblies and, more particularly, to a mold assembly with an adjustable mold core.

2. Description of Related Art

With the development of technology, portable electronic devices for imaging, such as digital cameras and mobile phones with camera lens modules, have all entered widespread use.

A typical camera lens module for a portable electronic device includes any of a variety of lenses, which can generally be classified either as aspherical plastic lenses or as aspherical glass lenses. Usually, a lens mold assembly is used to manufacture the two kinds of lens. The lens mold assembly includes an upper mold and a lower mold, which cooperatively form a mold core therebetween. The mold core is used to shape the lens. The mold core includes an upper mold core and a lower mold core. The upper mold includes an upper mold plate, and the upper mold core is fixed to the upper mold plate. The lower mold includes a lower mold plate, and the lower mold core is fixed to the lower mold plate. The shape of the lens, as well as the interior and/or exterior surface of the lens, depends on the shape and an interior surface of the mold core. In assembly, the lower mold core cannot be fixed precisely to the lower mold plate, and the upper mold core cannot be fixed precisely to the upper mold plate. Thus, high lens surface precision cannot generally be achieved.

The previously available mold assemblies have proven difficult to modify and to still achieve as high a precision of assembly as possible. Further, adjusting the distance between the upper mold core and the lower mold core has proven problematic.

What is needed, therefore, is a mold assembly that can overcome the above-mentioned shortcomings.

### SUMMARY OF THE INVENTION

In one embodiment thereof, a mold assembly includes a mold plate, a mold core, a mold holder, an elastic member, and an adjusting block. The mold plate has a receiving cavity defined therein. The mold plate is fixed to the mold holder, and the mold core is movably received in the receiving cavity. The elastic member abuts the mold plate and the mold core. The adjusting member is movably received in the receiving cavity and is configured to selectably drive the adjusting block relative to the mold plate, thereby facilitating an adjustment of the position of the mold core in the receiving cavity.

Other advantages and novel features will become more apparent from the following detailed description, when taken in conjunction with the accompanying drawings.

### BRIEF DESCRIPTION OF THE DRAWINGS

Many aspects of the mold assembly can be better understood with reference to the following drawings. These drawings are not necessarily drawn to scale, the emphasis instead being placed upon clearly illustrating the principles of the present mold assembly. Moreover, in the drawings like reference numerals designate corresponding parts throughout the several views.

FIG. 1 is an exploded isometric view of a mold assembly, in accordance with a preferred embodiment;

FIG. 2 is an assembled view of the mold assembly shown in FIG. 1; and

FIG. 3 is a sectional view of the mold assembly, taken along the III-III line in FIG. 2.

### DETAILED DESCRIPTION OF PREFERRED EMBODIMENTS

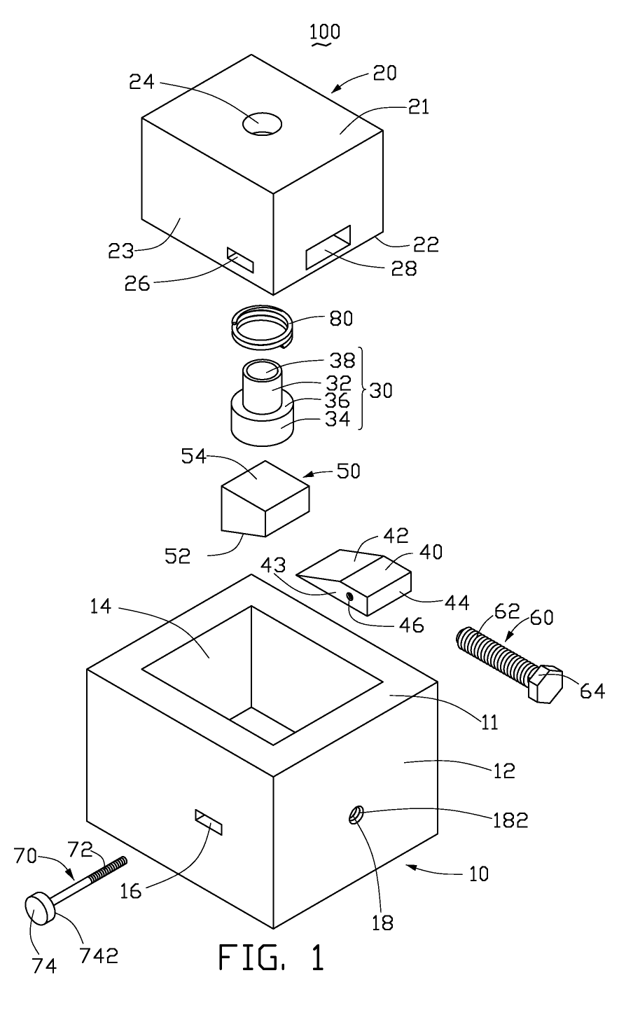

Referring to the drawings in detail, FIG. 1 shows a mold assembly 100. The mold assembly 100 includes a mold holder 10, a mold plate 20, a mold core 30, and an adjusting assembly (not labeled). The mold core 30 is received in the mold plate 20, and the adjusting assembly is used to adjust the position of the mold core 30 within the mold plate 20. The adjusting assembly includes an adjusting block 40, a block follower 50, an adjusting member 60, a fixing member 70, and an elastic member 80. The adjusting block 40, engaging with the block follower 50, is adjusted by the adjusting member 60 and is fixed by the fixing member 70 to the mold holder 10.

Referring to FIG. 1, the mold holder 10 is generally cube-shaped and includes an upper wall 11 and four adjacent sidewalls 12. A rectangular cavity 14 (i.e., a holder cavity) is defined in the mold holder 10 and is accessible via an opening through the upper wall 11. The rectangular cavity 14 has roughly the same size and shape as the mold plate 20 and functions to receive and hold the mold plate 20. One of sidewalls 12 has a first slot 16 defined therethrough communicating with the rectangular cavity 14, and another adjacent sidewall 12 has a through hole 18 formed therein to communicate with the rectangular cavity 14. The first slot 16 may have potentially any various kind of shape but is preferably of rectangular shape so to effectively act as a guide. The through hole 18 could have any various through hole structure yet is advantageously a screw hole with an internal screw thread 182.

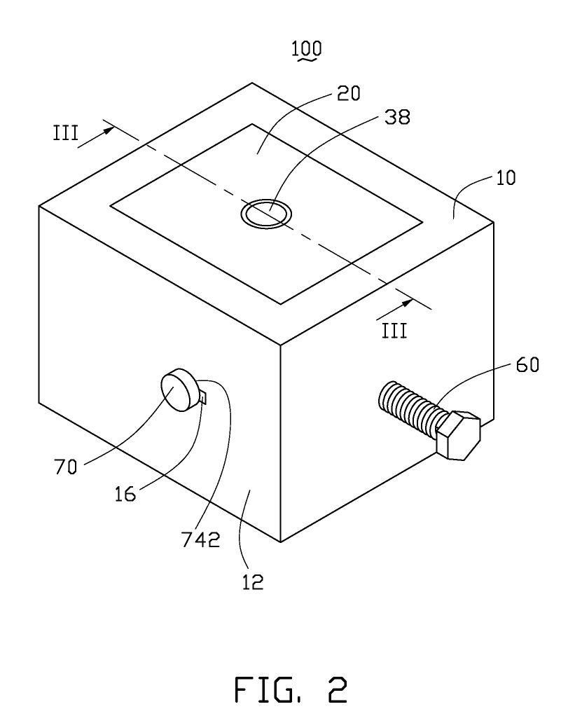

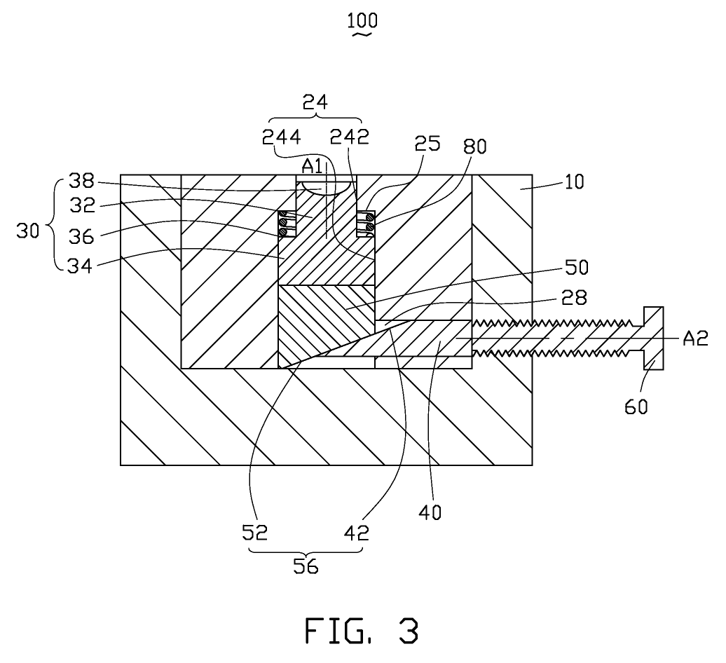

Referring also to FIGS. 2 and 3, the mold plate 20 is generally cube-shaped and includes an upper wall 21, a lower wall 22, and four adjacent sidewalls 23. A first receiving cavity 24 is defined through the upper wall 21 and the lower wall 22 and is centered about a line A1, located in the middle of the mold plate 20. A second slot 26 and a second receiving cavity 28 are defined through two adjacent sidewalls 23, respectively, and communicate with the first receiving cavity 24. The second receiving cavity 28 is defined around a central line A2, with the central line A2 being the central axis of the through hole 18 and the adjusting member 60. The line A2 is roughly perpendicular to the line A1.

The first receiving cavity 24 is cooperatively formed by a plurality of interior walls, including a transverse interior wall 25, of the mold plate 20. The transverse interior wall 25 is orthogonal to the line A1, interconnecting two interior walls (not labeled) that extend parallel to the line A1. The first receiving cavity 24 can be divided into a first receiving portion 242 and a second receiving portion 244. The first receiving portion 242 and the second receiving portion 244 may potentially have various kinds of shapes. The first receiving portion 242 is preferably of circular shape. The second receiving portion 244 is preferably rectangular in shape. A size of the second receiving portion 244 is bigger than that of the first receiving portion 242, and the second receiving portion 244 and the first receiving portion 242 are coaxially defined about the line A1. The second slot 26 is located corresponding to the first slot 16 and has roughly the same shape as the first slot 16 (i.e., the first slot 16 matingly corresponds with the second slot 26). The second receiving cavity 28 corresponds to the through hole 18 and has roughly the same shape as the adjusting block 40, so as to allow it to receive the adjusting block 40.

The mold core 30 includes a first engaging portion 32 and a second engaging portion 34. One end of the first engaging portion 32 abuts the second engaging portion 34 and is located at an end of the middle of the second engaging portion 34, thus forming a step portion 36 therebetween. A mold cavity 38 used to form articles (such as lenses) is defined in the opposite end of the first engaging portion 32. The first engaging portion 32 has roughly the same size and shape as the first receiving portion 242 of the mold plate 20 and is slidably received in the first receiving portion 242. The second engaging portion 34 may have any various shapes but is usefully circular in shape. The second engaging portion 34 is particularly advantageously dimensioned to be slidably received in the second receiving portion 244.

The adjusting block 40 is beneficially structured/dimensioned to be slidably and movably received in the second receiving cavity 28 of the mold plate 20. The adjusting block 40 is preferably generally wedge-shaped and includes the first inclined wall 42, a sidewall 43 adjacent to the first inclined wall 42, and an end wall 44 opposite to the first inclined wall 42. A screw hole 46 is defined in the sidewall 43 of the adjusting block 40, corresponding to the first slot 16 of the mold holder 10 and the second slot 26 of the mold plate 20, respectively.

The block follower 50 is preferably generally wedge-shaped and includes a second inclined wall 52 and a second end wall 54, opposite to the second inclined wall 52. The second inclined wall 52 of the block follower 50 faces the first inclined wall 42 of the adjusting block 40, and the first inclined wall 42 and the second inclined wall 52 abut each other. The first inclined wall 42 and the second inclined wall 52 cooperatively function as an engaging mechanism 56. The engaging mechanism 56 functions to transform a movement of the adjusting block 40 along the line A2 into a movement of the block follower 50 along the line A1.

The adjusting member 60, engaging in and extending through the through hole 18 of the mold holder 10, functions to enable the adjusting block 40 to move along the A2 line within the second receiving cavity 28 of the mold plate 20. The adjusting member 60 is advantageously a screw post with an external screw thread 62 and an opposite operating portion 64 (e.g., a hex head, as shown; or a head with a flat screwdriver slot or a Philips slot) formed thereon, the operating portion 64 facilitating the turning and resulting lateral movement of the adjusting member 60. The ability to selectably move the adjusting member 60 (e.g., via a screw thread action) and its corresponding abutment with the adjusting block 40 enables the controlled movement of the adjusting block 40 along the line A2.

The fixing member 70 is, usefully, a cylinder bar, having a screw portion 72 and a resisting portion 74 respectively disposed on two opposite ends thereof. The screw portion 72 is dimensioned to engage with the screw hole 46 of the adjusting block 40. By such an engagement, the fixing member 70 is able to help stabilize and help position the adjusting block 60. The resisting portion 74 can be, e.g., disk-shaped, and includes a resisting wall 742. The resisting portion 74, so configured, acts as a positioning button, via which the lateral location (i.e., within the width of the first slot 16) of the screw portion 72 can be adjusted. Meanwhile, the resisting wall 742 thereof prevents the resisting portion 70 from being screwed in too far and helps stabilize the resisting portion 70 relative to the corresponding sidewall 12. The friction between the resisting portion 70 and the resisting wall 742 can be temporarily reduced by untightening the screw connection of the fixing member 70 and the adjusting block 60, thus facilitating repositioning of the adjusting block 60. Upon repositioning, the screw connection can again be tightened to reestablish the friction between the resisting portion 70 and the resisting wall 742.

The elastic member 80 is structured and arranged to enable the mold core 30 to resist against the block follower 50 and the adjusting block 40. In particular, the elastic member 80 has a pair of ends, one of which biases against the transverse interior wall 25 and the other of which impinges against the step portion 36. The elastic member 80 is advantageously a coil spring, thereby allowing it to fit around the first engaging portion 32 and thus be kept in its desired location. However, the elastic member 80 may, potentially, have any spring or elastic element structure that enables it to fulfill its primary resistance function. An external diameter of the elastic member 80 is less than a diameter of the second receiving portion 244 of the first receiving cavity 24 of the mold plate 20, and an internal diameter of the elastic member 80 is more than a diameter of the first engaging portion 32 of the mold core 30.

In fabricating the mold assembly 100, the elastic member 80 is placed around the first engaging portion 32 of the mold core 30 with an end of the elastic member 80 contacting the step portion 36 of the mold core 30. The mold core 30, together with the elastic member 80, is inserted into the second receiving portion 244 of the first receiving cavity 24 and is then pushed toward the first receiving portion 242 of the first receiving cavity 24 by pressing the block follower 50 against the mold core 30. The mold core 30, together with the elastic member 80, is pushed until the first engaging portion 32 of the mold core 30 engages in the first receiving portion 242 of the first receiving cavity 24. In this case, the second end wall 54 of the block follower 50 resists/abuts a bottom of the second engaging portion 34 of the mold core 30, compressing the elastic member 80 with two ends thereof respectively resisting (i.e., biasing against) the step portion 36 of the mold core 30 and the interior wall 25 of the mold plate 20. The adjusting block 40 is inserted into the second receiving cavity 28 of the mold plate 20 until the first inclined wall 42 of the adjusting block 40 contacts the second inclined wall 52 of the block follower 50.

The mold plate 20, assembled with the adjusting block 40, the block follower 50, the mold core 30, and the elastic member 80, are cooperatively inserted into the rectangular cavity 14 of the mold holder 10. In this case, the screw hole 46 of the adjusting block 40, the second slot 26 of the mold plate 20, and the first slot 16 of the mold holder 10 are aligned with each other. The second receiving cavity 28 is aligned with the through hole 18 of the mold holder 10. The fixing member 70 is inserted through the first slot 16 and the second slot 26, in sequence, until the resisting wall 742 of the resisting portion 74 of the fixing member 70 resists the sidewall 12 of the mold holder 10. In this case, the screw portion 72 engages into the screw hole 46 of the adjusting block 40. The adjusting member 60 is aligned with the through hole 18 27 and is then rotated thereinto until an end thereof resists the first end wall 44 of the adjusting block 40. In this case, the external screw thread 62 of the adjusting member 60 engages with the internal screw thread 182 of the through hole 18.

In use of the mold assembly 100, the position of the mold core 30 within the first receiving cavity 24 may be slightly adjusted. For purpose of lifting up the mold core 30 within the mold plate 20, the resisting wall 742 of the fixing member 70 can be moved away from the sidewall 12 of the mold holder 10 (i.e., so as to temporarily remove the frictional bias therebetween) by operating the fixing member 70. By rotating the operation portion 64, the adjusting member 60 is rotated to move within the second receiving cavity 28 of the mold plate 20. Thus, the adjusting member 60 resists the adjusting block 40 to slidably engage with the block follower 50 to move within the receiving cavity of the mold plate 20. The gradual movement of the adjusting block 40 gradually lifts up the block follower 50 and the mold core 30 within the mold plate 20. Then, the fixing member 70 can be retightened so as to enable the resisting wall 742 thereof to fix to (i.e., frictionally bias against) the mold holder 10 again, maintaining the position of the mold core 30 within the mold plate 20. In this case, the elastic member 80 is compressed.

For purpose of lowering the mold core 30 within the mold plate 20, a similar process to that used for raising the mold core 30 is employed, except for a few obvious modifications. Once the resisting wall 742 is disengaged from the sidewall 12 using the fixing member 70, the operating portion 64 is rotated in a reverse direction. This reverse rotation causes the adjusting member 60 to move out from the second receiving cavity 28, allowing the elastic member 50 to expand. The expansion of the elastic member 80 provides a force to lower the mold core 30 and the block follower 50. The block follower 50 slidably engages with the adjusting block 40, thereby resisting the adjusting block 40 to move within the first receiving cavity 24 of the mold plate 20. Now sufficiently lowered, the fixing member 70 can then be enabled, causing the resisting wall 742 to fix to the mold holder 10 again, maintaining the position of the mold core 30 within the mold plate 20.

A main advantage of the mold assembly 100 is that the mold core 30 received in the mold plate 20 can be easily adjusted to move relative to the mold plate 20 by means of adjusting the adjusting member 60. The mold core 30 can move up and down relative to the mold plate 20 along a first longitudinal direction (line A1 shown in FIG. 3), while the adjusting member 60 and the adjusting block 40 can move along a second longitudinal direction (line A2 shown in FIG. 3), perpendicular to the first direction. The presence of the fixing member 70 allows a given position to be frictionally maintained, yet easily released to permit positional adjustment. There is no need to modify the mold assembly 100, thus reducing the production cost greatly.

In a further alternative embodiment, the block follower 50 and the mold core 30 can instead be formed integrally.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mold assembly, comprising:
a mold plate having a receiving cavity defined therein;
a mold core movably received in the receiving cavity of the mold plate;
a mold holder having a holder cavity defined therein, the mold plate being received in the holder cavity, the mold holder having a through hole defined therein;
an elastic member disposed between the mold plate and the mold core;
an adjusting block movably received in the receiving cavity of the mold plate and abutting the mold core; and
an adjusting member extending through the through hole of the mold holder and abutting the adjusting block, the adjusting member relative being able to be selectably moved in order to adjust a position of the adjusting block and to thereby drive the mold core to move relative to the mold plate.

2. The mold assembly as claimed in claim 1, further comprising a block follower; and
further wherein the adjusting block comprises a first inclined wall, the block follower comprises a second inclined wall and an end wall, the first inclined wall engages with the second inclined wall, and the end wall resists the mold core.

3. The mold assembly as claimed in claim 2, wherein the receiving cavity comprises a first receiving cavity and a second receiving cavity, the first receiving cavity being configured to receive the mold core, the elastic member and the block follower, the second receiving cavity being configured to receive the adjusting block.

4. The mold assembly as claimed in claim 3, wherein the mold core comprises a first engaging portion and a second engaging portion, the first receiving cavity comprises a first receiving portion and a second receiving portion, the first engaging portion being received in the first receiving portion, the second engaging portion being received in the second receiving portion, the block follower abutting the second engaging portion.

5. The mold assembly as claimed in claim 4, wherein the mold core further comprises a step portion between the first engaging portion and the second engaging portion, the receiving cavity being bounded by a plurality of interior walls of the mold plate, the elastic member comprising two ends, one end resisting the step portion, the other end resisting the interior wall.

6. The mold assembly as claimed in claim 1, further comprising a fixing member, the fixing member being configured to maintain the position of the adjusting block relative to the block follower and the mold plate.

7. The mold assembly as claimed in claim 6, wherein the fixing member comprises a screw portion and a resisting portion opposite to the screw portion, the adjusting block comprises a screw hole configured to receive the screw portion, and the resisting portion is configured to selectably fix the fixing member to the mold holder.

8. The mold assembly as claimed in claim 7, wherein the mold holder comprises a plurality of sidewalls, one sidewall having a first slot defined therethrough, the through hole of the mold holder being defined through another sidewall adjacent to the one sidewall, the mold plate having a second slot defined therethrough, the first slot and the second slot cooperatively receiving the fixing member therethrough.

9. The mold assembly as claimed in claim 8, wherein the resisting portion comprises a resisting wall, the resisting wall selectably engaging with the one sidewall having the first slot therein.

10. A mold assembly, comprising:
a mold plate having a receiving cavity defined therein;
a mold core movably received in the receiving cavity;
a mold holder configured for receiving and holding the mold plate;
an adjusting block being movably received in the receiving cavity; and
an adjusting member having a first longitudinal direction, the adjusting member being configured such that movement of the adjusting member along the first longitudinal direction thereof gives rise to the movement of the mold core along a second longitudinal direction perpendicular to the first longitudinal direction.

11. The mold assembly as claimed in claim 10, wherein the mold holder has a through hole and a holder cavity defined therein, the adjusting member is configured to extend through the through hole, and the mold plate is received within the holder cavity.

12. The mold assembly as claimed in claim 10, further comprising a block follower and an elastic member, and wherein the adjusting block comprises a first inclined wall, the block follower comprising a second inclined wall and an end wall, the first inclined wall engaging with the second inclined wall, the end wall resisting the mold core, and the elastic member biasing against the mold plate and the mold core.
